(19) United States
(12) Patent Application Publication
(10) Pub. No.: US 2012/0166233 A1
(43) Pub. Date: Jun. 28, 2012

(54) Method And Apparatus For Enhancing Consumer Awareness Of Utility Consumption And Cost Data

(75) Inventors: Michael S. Wengrovitz, Concord, MA (US); Tom Janiszewski, Andover, NJ (US)

(73) Assignee: Alcatel-Lucent USA Inc., Murray Hill, NJ (US)

(21) Appl. No.: 12/975,564

(22) Filed: Dec. 22, 2010

(51) Int. Cl. G06Q 10/00; G08C 19/16

(52) U.S. Cl. 705/7.11; 340/870.02

(57) ABSTRACT

A user platform (“Smart Grid Phone” (SGP)) facilitates enhanced consumer awareness of utility consumption and cost data associated with a user premises. In one example, the SGP provides electrical energy consumption and cost data and may be implemented with interfaces to either legacy electric meters or next-generation smart electric meters. Novel methods are described herein for coupling the SGP to an external energy monitoring service to receive externally-produced content (such as historical energy usage displays) and deriving supplemental content such as annotated energy events, time-varying pricing data, and customized displays which may be displayed simultaneously with or alternatively to the externally-produced content.

### FIELD OF THE INVENTION

This invention relates generally to communication systems and, more particularly, to communications systems that interface with public utility metering devices (including, e.g., electricity, natural gas and water meters) to provide enhanced utility consumption and cost information to consumers.

### BACKGROUND OF THE INVENTION

Public utility services are well known in which an organization (“utility company”) maintains an infrastructure for a public service and, using that infrastructure, delivers a corresponding service to the public such as, for example, electricity, natural gas or water service. At the end user premises, metering devices measure the user's utility consumption, and the utility company periodically bills the customer according to the consumption information obtained from the meter.

Historically, and in many existing systems (a.k.a., “legacy” systems), the utility company performs manual reading of the meters (e.g., by a human meter reader walking around neighborhoods to read consumer meters, or driving by with a truck and remotely querying consumer meters by a radio connection). Typically, in such systems, consumer meters are checked on a relatively infrequent basis (e.g., monthly or bi-monthly) and the customer is charged a flat rate based on the total utility consumption during the relevant period. More recently, at least in the case of electrical utilities, there is a trend toward next-generation “smart meters” that enable the electric company to monitor consumer consumption data in nearly real-time. An electrical distribution system equipped with smart meters is often referred to as a “smart grid.” One of the advantages of the smart grid is that it enables the electric company to implement time-dependent pricing policies, for example, to charge higher rates during hours of peak energy demand and lower rates at different times of day when there is lower energy demand.

The supply-and-demand coupling operates most efficiently when both the utility provider, e.g., the electric company, and the utility demander, i.e., the end user consumer, are both made aware of consumption and cost data, yet consumers are often not aware, or at least not sufficiently aware of the details of their utility consumption and/or their utility bill. For example in the case of electrical service, consumers may not know what appliances consume what portions of the total bill, how their own energy usage compares to that of other consumers in similar homes and geographic areas, or how to potentially change their overall electrical consumption behavior without making major compromises to comfort and convenience. Accordingly, there is a need to enhance consumer awareness of utility consumption and cost information so that consumers can proactively manage their utility consumption and to more optimally consume utility resources in their homes and businesses. Advantageously, enhanced utility consumption and cost data will be made available to consumers having either legacy meters or next-generation smart meters.

### SUMMARY OF THE INVENTION

This need is addressed and an advance is made in the art by a user platform (in one example, embodied in a modern telephone set, termed a “Smart Grid Phone” (SGP)) as the means for conveying substantially real-time utility consumption and cost information to the consumer. The SGP in one embodiment has always-on internal CPU processing, connectivity with the Internet, touch-screen display, and voice input/output capabilities, may be advantageously located in a convenient place within the home, and thereby provides an ideal interface for end-users.

### BRIEF DESCRIPTION OF THE DRAWINGS

The foregoing and other advantages of the invention will become apparent upon reading the following detailed description and upon reference to the drawings in which:

FIG. 1 is a schematic diagram of a first exemplary system of the prior art for measuring consumer energy consumption data;

FIG. 2 is a schematic diagram of a second exemplary system of the prior art for measuring consumer energy consumption data;

FIG. 3 is a representation of an exemplary display from an online energy monitoring service of the prior art;

FIG. 4 is a schematic diagram of a Smart Grid Phone (SGP) implemented with an interface to a legacy electric meter according to one embodiment of the invention;

FIG. 5 is a schematic diagram of a Smart Grid Phone (SGP) implemented with an interface to a smart meter according to one embodiment of the invention;

FIG. 6 is an exemplary representation of the display of FIG. 3 annotated with significant energy consumption events according to one embodiment of the invention; and

FIG. 7 is an exemplary representation of the display of FIG. 3 annotated with time-dependent energy costs according to one embodiment of the invention.

### DESCRIPTION OF THE PREFERRED EMBODIMENT(S)

There is growing awareness of the importance of making utility consumption and cost data available to consumers. For example, in the case of electrical energy usage, hobbyist measurement devices have been available on the market that use A/C current transducers coupled to the power wires incoming to homes. These devices have two components—one component typically resides in the utility room and has two current transducers (one per A/C phase) with a low-power radio transmitter that relays its sensor measurement data via RF, and a second component which is a receiver/display located somewhere in the interior of the home. By viewing the receiver/display component, a consumer can see total current electrical consumption in real-time along with some comparison data such as morning, afternoon and evening summaries.

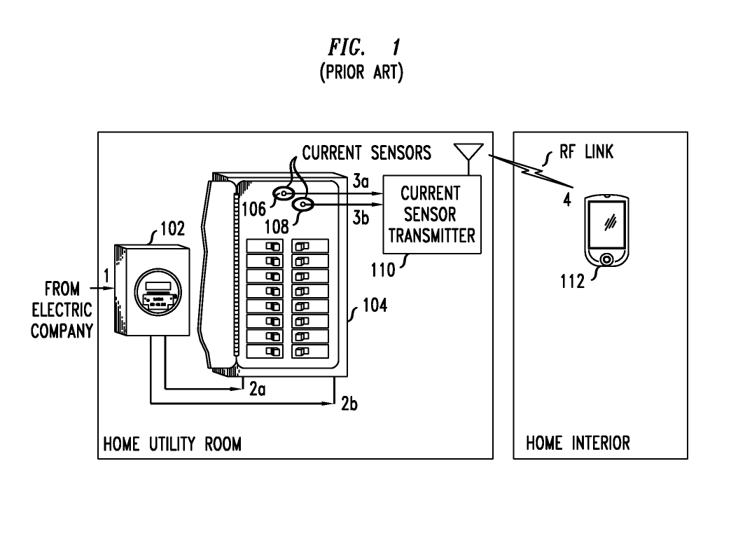

On such prior art system is depicted in FIG. 1. Electricity from the grid enters the customer's premises via a legacy power meter 102 in Step 1, two phases of A/C power are distributed to individual circuits in the customer's breaker box 104 in Steps 2a and 2b, measurements from current transducers 106, 108 coupled to the two phases are sent to a radio frequency (RF) transmitter 110 in Steps 3a and 3b, and this measurement data is relayed via RF link in Step 4 to a small inexpensive receiver/display 112 in the customer's home or business which performs limited processing on the current sensor measurements and shows results. Typically, the display may show only rudimentary consumption and cost data such as, for example, current energy consumption in KWh, cost per month, cost per day, and KWh consumed over the past 7 or 30 days. The display is difficult to interpret and uses only a fixed-cost price per KWh which must be manually entered by the consumer. With such a conventional system, the consumer cannot know what his/her cost and consumption data was for shorter, more manageable time intervals such as for example, the 6-7 PM dinner hour or for the 9-10 PM laundry hour. A further limitation is that real-time costing changes by the utility are not supported—the receiver/display allows only for a single and fixed per-KWh cost, which must also be entered manually.

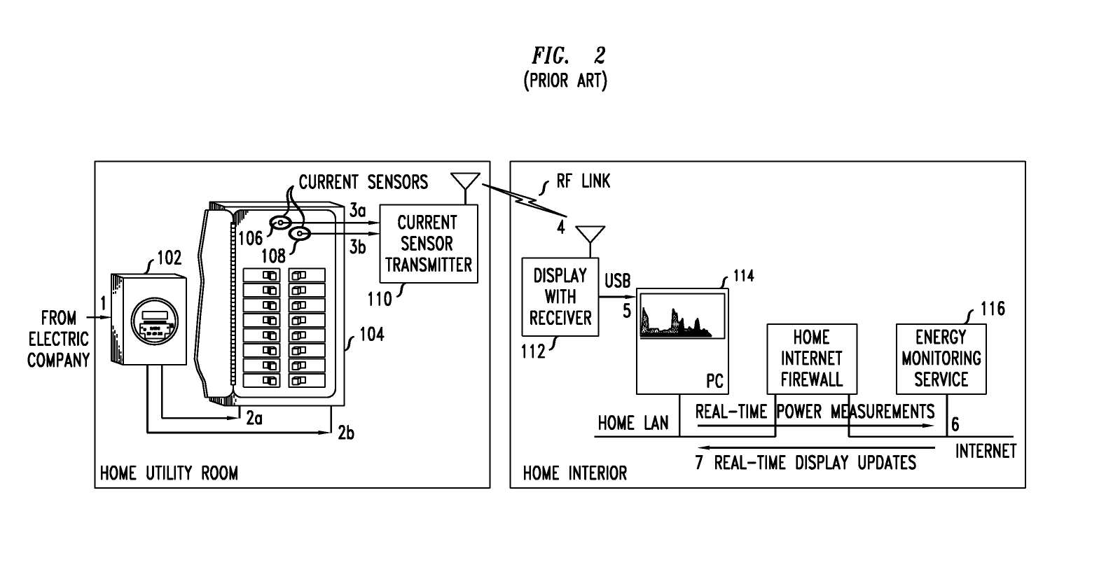

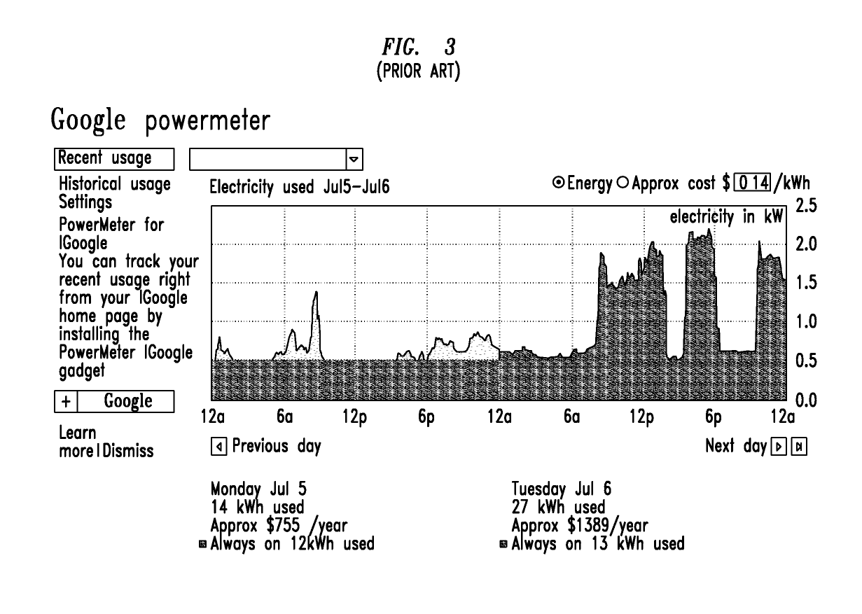

Another exemplary prior art system is depicted in FIG. 2. Similarly to the system of FIG. 1, electricity from the grid enters the customer's premises via a legacy power meter 102 in Step 1, two phases of A/C power are distributed to individual circuits in the customer's breaker box 104 in Steps 2a and 2b, measurements from current transducers 106, 108 coupled to the two phases are sent to a radio frequency (RF) transmitter 110 in Steps 3a and 3b, and this measurement data is relayed via RF link in Step 4 to a receiver/display 112 in the customer's home or business. However, in the system of FIG. 2, the display 112 is coupled in Step 5 via a short USB cable to a personal computer (PC) 114 which can more readily display historical measurements. Further, the PC 114 may be connected to the Internet in Step 6 and linked to an online energy monitoring service 116 (for example and without limitation, Google Power Meter) that is adapted to deliver display content, and near real-time display updates corresponding to the utility consumption information at Step 7. An exemplary display from the Google Power Meter service is shown in FIG. 3. As shown, the display comprises a plot of historical energy usage over a 24-hr period (e.g., July 5 to July 6); a report of energy consumption in KWh used each day; and approximate annual cost associated with the daily energy consumption.

The system of FIG. 2 is an improvement relative to that of FIG. 1 in that the end user can now see his/her historical consumption data. However, significant limitations still exist. For example, the display is typically not physically located in a convenient place such as the kitchen, since it is coupled via a short USB cable to a PC, which is often located elsewhere in the home. This makes it awkward and inconvenient for the consumer to view and thereby to remain fully-aware of electrical energy usage. For example, the consumer must walk upstairs to a study or to some other room in the house where the PC may be located, so as to momentarily view the meter data. Furthermore, the PC itself consumes energy and must be always-on in order to display and relay energy consumption data. This is not efficient, nor is assuring that the communications application on the PC is always running. Still further, the prior art display of FIG. 3 is limited in that it does not show real-time cost data and it is difficult for the consumer to fully ascertain energy usage and cost data associated with short time intervals such as, for example, how much electricity was used and what the cost was for the 6-7 PM dinnertime cooking process, how much it costs to do laundry from 9-10 PM, etc.

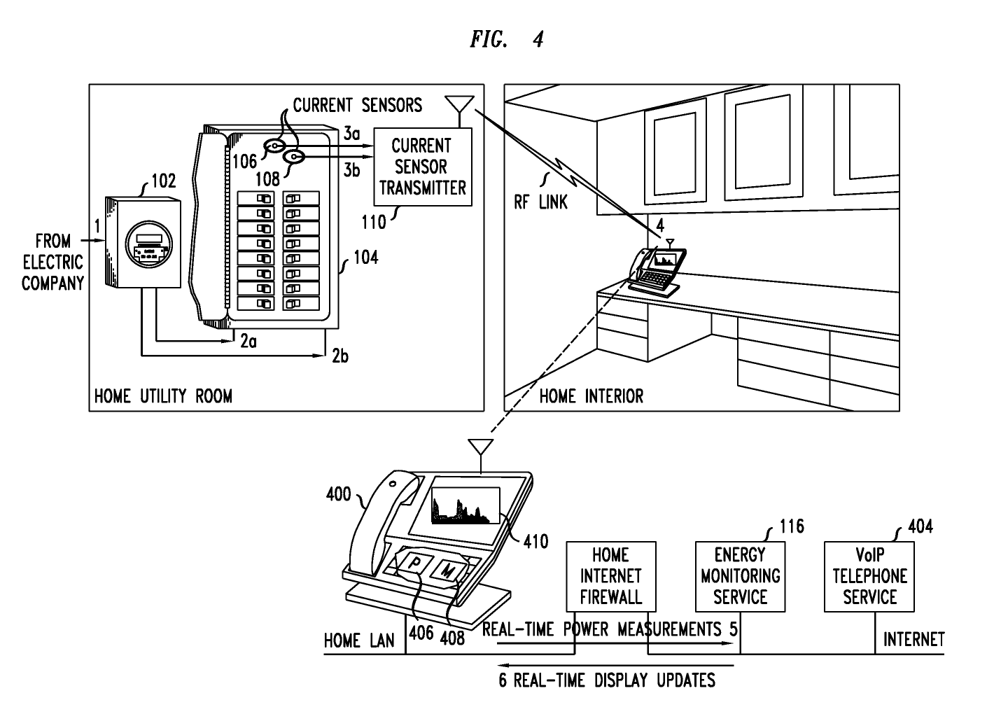

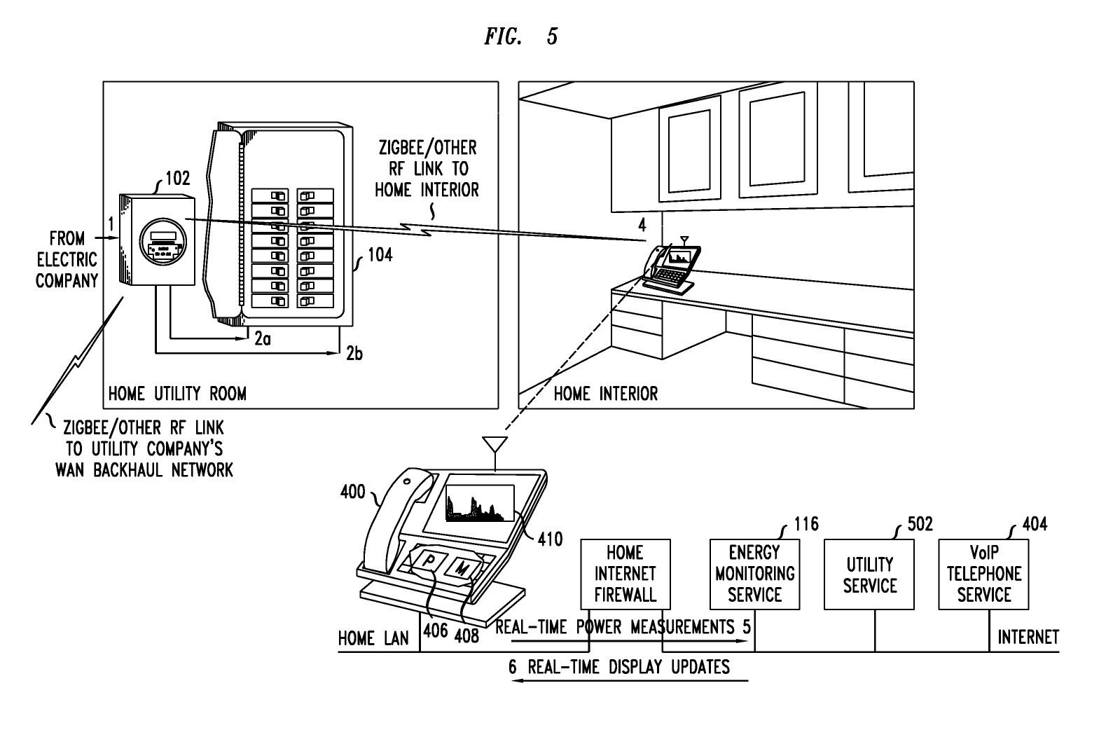

FIG. 4 and FIG. 5 illustrate systems for further enhancing consumer awareness of utility consumption and cost data according to two exemplary embodiments of the invention, having respective interfaces to a legacy electric meter (FIG. 4) or smart meter (FIG. 5). The heart of the system is a user platform 400 (as shown, embodied in a modern telephone set, termed a “Smart Grid Phone” (SGP)) as the means for conveying substantially real-time utility consumption and cost information to the consumer. The SGP 400 may comprise, for example and without limitation, an Alcatel Lucent 8000 series set, which has a programmable internal processor (CPU) 406, a memory 408, a touch-screen display 410, one or more USB ports for external peripherals, IP connectivity for voice-over-IP (VoIP) and other web services, and the capability for executing various internal software/firmware programs.

Therefore, the SGP provides a conveniently-located, readily-accessible, and easy-to-use interface for the end-user as relates to the smart-grid and energy consumption, as well as serving as the user's IP-based telephone set.

Referring to FIG. 4 (i.e., the legacy electric meter implementation), electricity from the grid enters the customer's premises via a legacy power meter 102 in Step 1, two phases of A/C power are distributed to individual circuits in the customer's breaker box 104 in Steps 2a and 2b, measurement data is obtained from two current transducers 106, 108 and sent to a radio frequency (RF) transmitter 110 in Steps 3a and 3b, and this measurement data is relayed via RF link in Step 4 to the SGP 400.

As shown, the SGP 400 maintains Internet connectivity at step 5 to an online energy monitoring service 116 (for example and without limitation, Google Power Meter). The SGP delivers real-time utility consumption information to the energy monitoring service at step 5 and in one embodiment, receives near real-time display content and updates corresponding to the utility consumption information at Step 6. The display content and display updates received from the energy monitoring service define externally-produced content.

Further, the SGP maintains internet connectivity to a VoIP telephone service provider 404 and the SGP thereby acts as the user's IP-based telephone set. In addition to providing standard PSTN dial-in/dial-out functionality for the home and optionally acting as a browser client to the web, the SGP can internally process and communicate its real-time power consumption measurements to one or more online energy services, using its programmable application functionality.

Referring to FIG. 5 (i.e., the smart meter implementation), electricity from the grid enters the customer's premises via a smart meter 102 in Step 1 and two phases of A/C power are distributed to individual circuits in the customer's breaker box 104 in Steps 2a and 2b. It is noted, in contrast with the previous system with legacy electric meters, there is no need to utilize A/C current transducers coupled to the incoming electric wires, since this current monitoring is already performed within the smart meter itself. At step 3, the smart meter relays real-time electrical consumption data to the utility company. The mechanism for backhauling data from the smart meter across the metropolitan area to the utility company's billing infrastructure varies across regions. In some cases, a fiber-optic backbone core is deployed across the town, in other cases WiMax radios are used, and in other cases powerline-based communications are used, etc. However, the typical means for telemetering data from the smart meter itself to the wide area backhaul network is via a short-range, secure, low-speed RF link, such as Zigbee. The smart meter sends its real-time consumption data from the home to a nearby utility pole via the Zigbee or similar RF link, and this data is then backhauled to the utility company via one of the various means.

As shown, the real-time consumption data is simultaneously relayed to the SGP 400 in Step 4 via the Zigbee or similar secured RF link. The SGP's RF receiver could be a USB-based receiver dongle attached to one of its USB ports, but might also be directly built-in to the SGP. In this preferred embodiment, the SGP has access to the end-user's raw electrical energy consumption data. Alternatively or additionally to receiving consumption data via an RF link to the Smart Meter, the SGP may access consumption data via an online connection to the utility's database and infrastructure, depicted as Utility Service 502 in FIG. 5. It is contemplated that raw energy consumption data would be preferable to data provided by the utility company, for example, raw data may provide more granular details of electrical energy consumption throughout the day, whereas consumption data provided by the utility company may be summarized, filtered, condensed or the like.

Similarly to FIG. 4, the SGP 400 maintains Internet connectivity at step 5 to an online energy monitoring service 116 (for example and without limitation, Google Power Meter). The SGP delivers real-time utility consumption information to the energy monitoring service at step 5 and in one embodiment, receives near real-time display content and updates corresponding to the utility consumption information at Step 6. The display content and display updates thereby define externally-produced content.

According to principles of the present invention, the SGP 400, having special software/firmware, always-on internal CPU processing, connectivity with the Internet, touch-screen display, and voice input/output capabilities, and ability to process and communicate real-time power consumption measurements to one or more online energy services, may be implemented to enhance consumer awareness of utility consumption and cost data in a variety of unique and creative ways. For example and without limitation, it is contemplated that the SGP 400 may be implemented as follows:

1. Using the SGP with the Google Power Meter Service

In one embodiment, the SGP can authenticate as a client with the Google Power Meter service, and upload the real-time electrical power measurements, relayed to it via the RF link (FIG. 4) or Zigbee link (FIG. 5) from the utility room. The display on the SGP can also be used to show energy-related consumption, cost curves and other related results. For example, the display on the SGP might be used to show nominal curves and data displays externally obtained from the Google Power Meter service. However, in contrast with prior-art PC-based browser displays of Google Power Meter data, such as shown in FIG. 3, the SGP would automatically and periodically refresh its display so that it remains completely and fully up-to-date. It is contemplated that the consumer will be able to simply glance at the SGP's always-on display to see a completely up-to-date view of the current and past usage without the need for clicking, double-clicking, page-refreshing, or any other manual operations. In one embodiment, the SGP further executes special software/firmware programs to display additional enhancements (e.g., without limitation, supplemental content such as annotated energy events and cost data) additionally to the externally-obtained energy consumption content.

Using a dedicated appliance such as the SGP that automatically updates its one or more views, contrasts with the prior-art PC-based browser access to Google Power Meter, whereby the end-user must manually login using the iGoogle portal and must also then manually and continually refresh by mouse-clicking or double-clicking in order to see up-to-date energy consumption results. The appliance-based SGP acts a true and automatic meter, in contrast to existing PC-based browser displays which require manual operations for refreshing results.

### 2. Using the SGP to Create Customized Cycling Displays of Energy Consumption Data

It is contemplated that the SGP may interface with exposed APIs (application programming interfaces) of the Google Power Meter service. In one example, the APIs can be used by the SGP to authenticate and to upload real-time measurement data, relayed to the SGP from utility room via an RF link (FIG. 4) or Zigbee link (FIG. 5), across the internet to the online Google Power Meter service. Whereas these APIs have typically been used only to upload data, the SGP might also use the APIs to download data as part of its process for creating and presenting customizable displays.

In contrast to the prior-art browser-based display of Google Power Meter, the SGP in one embodiment may connect to the Google Power Meter service to access and download data, so as to compute and present various kinds of customized displays and summaries. Such displays might cycle through different varied presentations of the consumer's energy consumption data. For example and without limitation, first a zoomed-in curve showing usage over the past one hour may be displayed for five seconds, next a zoomed-out curve showing usage over the past 48 hours may be displayed for six seconds, next a bar-graph showing usage over the past week may be displayed for three seconds, next a screen summarizing cumulative total consumption and cost may be displayed for seven seconds, and so on. In the preferred embodiment, the end-user would be able to select and configure the detailed content and data organization relating to how such screens are presented and cycled.

### 3. Using the SGP as an Appliance for Multiple Online Energy Monitoring Services

In another example, the SGP may be used to simultaneously access and upload data to other online services. For example, Pachube is yet another online service to which energy data can be uploaded and made available to applications via its APIs. The SGP might cycle through various displays using the upload/download APIs from Pachube and/or other multiple online services, so as to present the user with various perspectives on his/her energy consumption. The SGP might also use its own internal processing, in addition to or instead of online services, to process and present various views of electrical consumption data. There are many possibilities and combinations.

### 4. Annotating Energy Events on the SGP's Display

In yet another example, the SGP might also annotate significant energy events on its one or more cycling displays of data, so that end-users become more aware of the details of the consumption. For example, the SGP might implement various algorithms that perform signal processing on the total two-phase measured current versus time waveforms, so as to identify and correlate characteristic step changes and other features of major constituent components of energy consumption. Although there has been algorithm work done in the past relating to Non-Intrusive Load Monitoring (NILM) which seeks to identify which electrical devices are contributing to the total electrical load, it is believed this algorithm work may not be directly applicable here, due to the low sampling rates of typical A/C current transducers on the market. Performing this constituent-component processing within an edge device itself, such as within the SGP telephone set, rather than centrally at the utility company, is believed to be novel. Furthermore, the outputs of existing or new NILM algorithms used as a means of annotating and labeling real-time energy curves has not been previously proposed.

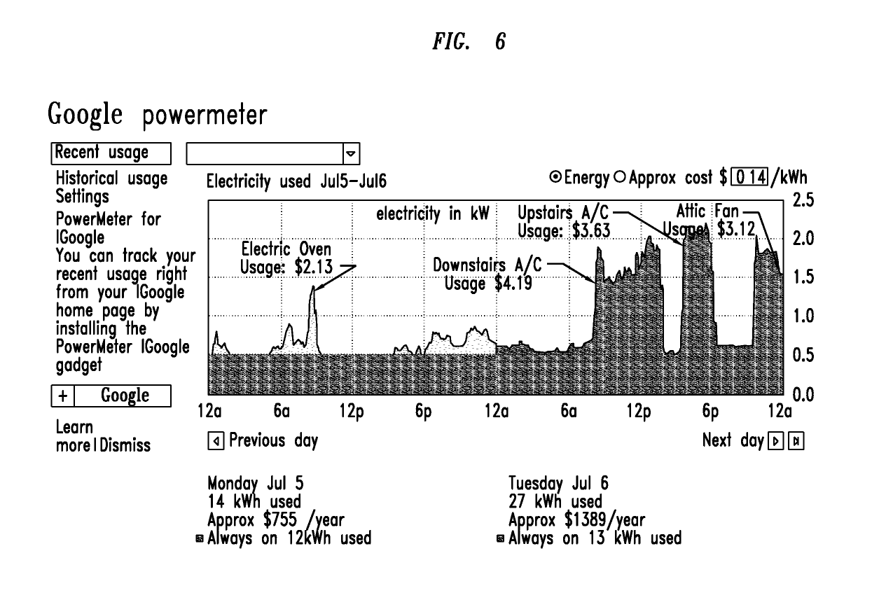

Referring to FIG. 6, the SGP might use its internal event detection algorithms to display annotated energy events overlaying the nominal display of consumption data from Google Power Meter or other services. As best observed by comparing FIG. 6 to the nominal display shown in FIG. 3, the annotated energy events identify constituent components attributed to various energy events (four shown), and costs associated with usage of the component. In particular, the energy event occurring roughly at 9 am on July 5 is attributed to electric oven usage, costing $2.13; the energy event occurring roughly between 8 am and 2 pm on July 6 is attributed to downstairs air conditioner (A/C) usage, costing $4.19; the energy event occurring roughly between 4 pm and 6 pm on July 6 is attributed to upstairs A/C usage, costing $3.63; and the energy event occurring roughly between 10 pm and 12 am on July 6 is attributed to attic fan usage, costing $3.12.

### 5. Annotating Real-Time Pricing Data on the SGP's Display

In a smart-grid electrical distribution system, the price of electricity per KWh set by the utility company can be a time-dependent function. For example, the utility might adjust the rate based on its own costs which fluctuate in real-time, and/or based on the specific end-user's current or historical consumption, and/or based on total consumption for a population of users, etc. With smart meters, the utility company is able to measure the time-dependent consumption and also has the ability to bill in a time-dependent way. For example, the utility company might bill differently for the 6-7 PM dinner hour time period when many kitchen cooking appliances are being used, than for 9-10 PM time period.

Presumably, end-users would also like to be fully informed of the time-dependent costs they are being assessed. For example, knowing that electricity costs more at one time later today, and less at some other time later today or tomorrow, might impact user behavior. It is contemplated that with the prevalence of smart metering, utility companies will publish their real-time time-dependent costing-data, thereby allowing their customers to remain more fully informed about their purchasing costs.

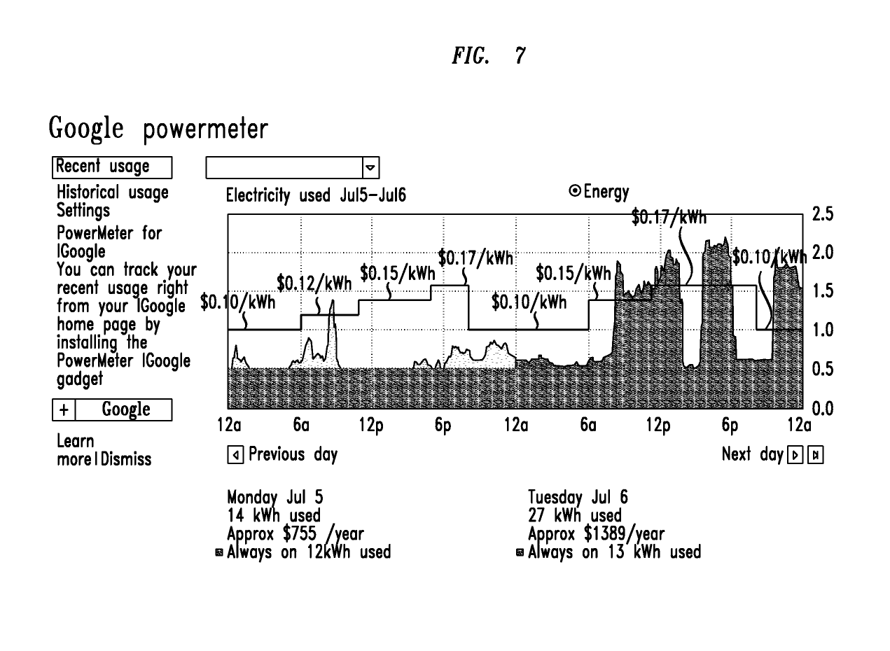

In yet another example, the SGP might access the real-time costing data from the utility company, provided by the utility company as on online service, to annotate its displays. One example of this is depicted in FIG. 7, where the SGP display shows a view of the time-varying cost assessed by the utility company, overlaid on top of the nominal display of the end-user's electrical consumption such as provided from Google Power Meter or other services. Optionally, the SGP might display future costs, as well as past costs. For example, the end-user might be able to touch the right-hand side of the SGP's touch-screen, so as to scroll to tomorrow's date, in order to view the utility's projected per-KWh costs. In this way, the end-user might become informed of exactly how his/her costs were, are, and will be assessed, and might also make corresponding changes to consumption behavior. For example, knowing that electricity costs more tomorrow afternoon, and less during the evening, might cause the end-user to use his/her electric dryer tomorrow evening.

Past and future cost data along with consumption usage data might form the basis for tips and recommendations offered by the SGP, optionally operating in conjunction with an online service. For example, the SGP might recommend (either via a text message on its display, or via voice output) recommendations about cost savings, such as if you use your electric dryer from 9-10 PM instead of from 6-7 PM, you will likely save $27 over the next 12 months. There are many possibilities and variations that exploit the SGP's usage, processing, and output of real-time costing data provided by the utility company.

### 6. Using the SGP's Touch Screen for Improved Interaction

The SGP's touch-screen display might also be used in conjunction with energy curves for improving the overall end-user interaction. In one example, the end-user gesture might be pinching together two fingers while touching the SGP display to show a longer history of consumption, or un-pinching two fingers while touching the display to show a more granular presentation.

In another example, the end-user might also momentarily touch various regions on the SGP's touch-screen to first compute, and then display, energy cost. For example, touching the display somewhere near the 6 PM point might show the total price for some fixed temporal region, such as from 6-7 PM, or from 5:30 PM to 6:30 PM. Or, perhaps the user might touch with two fingers, and then pinch or un-pinch so as to designate the temporal region and the corresponding price. For example, when two fingers are touched to the SGP's touch-screen, then slowly un-pinched near the 6 PM point, the region and calculated cost might change from 5:45-6:15/$2.10 to 5:30-6:30/$2.40, etc. The user might also double-touch the SGP screen so as to switch displays, switch services, etc. There are many possibilities and variations for this optional end-user interaction with the SGP's touch-screen interface.

### 7. Using the SGP's Audio Input/Output Functionality

In addition to the improved touch-screen user interface capabilities, the SGP's built-in audio input/output capabilities could also be used. For example, the SGP might emit a chirp, beep, ring or other alarm sound, thereby alerting the end-user to a significant event such as an unusually high or low daily consumption of electrical energy. Or, the alert sound might be triggered by a message from the electric utility company, advising its consumers to conserve energy on a particularly hot day. In this case, when the end-user acknowledges the message alert, he/she might either view the message as a text display on the SGP's screen, or alternately hear the message as audio content played-out from the SGP's built-in speaker.

The SGP's audio output capabilities might be used in other ways. For example, the SGP might present via audio output various statistics and summaries regarding usage, such as “Your daily summary was approximately fifty one kilowatt hours, which costs six dollars and seven cents. This is five percent below your normal usage, but ten percent above similar homes in your area”. Or, an example audio output from the SGP might be “Here is today's energy-saving tip: lowering the temperature of your hot water heater by five degrees would save you approximately thirteen dollars per month”. Audio announcements might be delivered automatically, such as in the case of an alarm or alert, or only after the end-user opted-in by touching the screen. The SGP might use its internal text-to-speech processing or voice synthesis techniques to compose such messages, or alternately might interoperate with an online service to create the audio announcements.

The SGP's audio input capabilities may also be used in various ways. For example, the user-end might speak to the SGP, thereby commanding it to change its various display options, or causing it to speak back various summaries of energy consumption, etc.

### 8. Using the SGP's Telephone Functionality

The telephonic capabilities built-in to the SGP might be used in various ways relating to electrical energy consumption and its cost. For example, the end-user might simply touch a click-to-call link, or a push-to-talk link, on the SGP's energy display, and would then be immediately connected to a human agent at the electric utility company, who could then verbally discuss specifics of electrical energy usage, provide tips and insights for better conservation, answer the end-user's questions, etc. Preferably, this simple touch action would also cause a screen-pop on the utility company agent's PC, or on some other type of agent user interface, displaying various views and data summaries of this particular end-user's electrical energy consumption.

The SGP might also dial-out to one or more end-user telephone numbers, such as for example when an alarm or alert condition occurred. For example, if the end-user was remote, or on vacation, and a high, or low, or otherwise abnormal electrical energy usage event occurred, the SGP might telephone call the end-user and inform him/her of this alert condition. The end-user might also be able to dial-in to the SGP to hear various electrical energy statistics and summaries, for example by entering a PIN code, entering DTMF digits or via speech recognition. There are many possibilities and variations.

### 9. Using the SGP as a Data Server for Smartphones

The SGP might also act as a data server for delivering information related to the energy measurement data it collects and processes from its current sensors. For example, the SGP might serve up web pages suitable for display on the end-user's mobile phone or smartphone. Or, the SGP might send text messages, email summaries, twitter messages and the like, using formats, syntax and conditions that are customizable by the end-user via the SGP's touch screen interface, via voice input commands, or via remote access to the SGP. For example, the SGP might send customized daily or weekly email summaries to the end-user's iPhone or Android, or perhaps only when some unusual activity occurred, etc. There are many possibilities and variations.

### 10. Using the SGP for Water and Gas Consumption Data

Alternatively or additionally to monitoring and displaying the end-user's electricity consumption results, the SGP might also be used to monitor water and gas consumption. In the typical system architecture, a Zigbee-enabled gas meter, and/or Zigbee-enabled water meter, might first relay its data to the smart electric meter, which in turn would backhaul the total set of data back to various electric, water and gas companies. With this system, the water or gas company might also assess time-dependent charges, so as to impact user demand.

In one embodiment, the smart meter would also relay data to the SGP's external or internal Zigbee receiver, so the SGP would have access to the raw data. In another embodiment, the SGP would only access the data via its online internet connections.

Many of the above features and benefits of the SGP described above are applicable to water and gas scenarios. For example, the end-user might see cycling displays of electrical, water and gas usage, might receive tips and specific advice relating to usage and efficiency, might be easily connected to speak a human agent at each utility company, might receive alarms and alerts, etc. For those devices that are controllable, the SGP might also provide touch-screen or voice control. For example, the end-user might be able to lower the internal temperature of a gas-fired hot water heater. There are many other possibilities, variations and extensions of the SGP operating in a multi-utility scenario.

FIGS. 1-7 and the foregoing description depict specific exemplary embodiments of the invention to teach those skilled in the art how to make and use the invention. The described embodiments are to be considered in all respects only as illustrative and not restrictive. The present invention may be embodied in other specific forms without departing from the scope of the invention which is indicated by the appended claims. All changes that come within the meaning and range of equivalency of the claims are to be embraced within their scope.

For example, the described embodiments herein refer to a preferred “Smart Grid Phone” (SGP) embodying a modern telephone set as a preferred user platform for enhancing consumer awareness of utility consumption and cost data. However, it will be appreciated that the user platform may be implemented in any number of alternative modalities including, without limitation, laptop computer, desktop computer, personal computer (PC), television or mobile computing device, personal digital assistant (PDA), tablet PC or mobile phone, nominally including a web browser for accessing Internet contents and services. It should be apparent that various exemplary embodiments of the user platform may be implemented in hardware and/or firmware. Furthermore, various exemplary embodiments may be implemented as instructions stored on a machine-readable storage medium, which may be read and executed by at least one processor to perform the operations of the user platform. A machine-readable storage medium may include any mechanism for storing information in a form readable by a machine including, without limitation, read-only-memory (ROM), random-access memory (RAM), magnetic disk storage media, optical storage media, flash-memory devices and similar storage media. The embodiments are also intended to cover computers or programmed to perform the steps of methods described herein.

Further, the described embodiments herein refer to the Google Power Meter service as a preferred online energy monitoring service for receiving display content such as historical electrical energy consumption data. However, it will be appreciated that alternative external services may exist or may be developed in the future for producing historical energy consumption data or other externally-produced content, and the described embodiments may utilize such services alternatively or additionally to the Google Power Meter Service.

The term “externally-produced content,” as used herein, shall refer to data content or updates that are produced externally from the SGP platform. For example and without limitation, the SGP platform 400 may receive externally-produced content from a content provider such as the Google Power Meter energy monitoring service; or from a utility service 502. The externally-produced content may comprise, without limitation, numeric data, graphs, text or any other communication modality suitable for communicating utility consumption and/or cost data.

The term “supplemental content,” as used herein, shall refer to content that is displayed, produced or communicated by the SGP as an enhancement or alternative to externally-produced content; and which is derived in one embodiment by the SGP processing externally-produced content and/or utility consumption information. For example and without limitation, annotated energy events such as shown in FIG. 6 and/or real-time pricing data such as shown in FIG. 7 define supplemental content.

What is claimed is:

1. In a communication system including a user platform operably connected to a utility meter, the utility meter and user platform being operable to obtain utility consumption information corresponding to utility services used at a customer premises, a method comprising the user platform:
communicating the utility consumption information to a content provider that is adapted to deliver display content corresponding to the utility consumption information, the display content defining externally-produced content;
receiving the externally-produced content;
processing one or more of the externally-produced content or the utility consumption information to derive one or more instances of supplemental content, wherein the supplemental content is adapted to supplement the externally-produced content; and
displaying at least a portion of the supplemental content simultaneously with the externally-produced content.

2. The method of claim 1, wherein the utility meter comprises one of a legacy meter and a smart meter associated with an electrical utility, wherein the content provider comprises an online energy monitoring service and wherein the externally-produced content includes one or more displays of historical electric energy consumption data associated with the customer premises.

3. The method of claim 2, wherein the step of processing comprises:
detecting one or more significant energy events associated with the historical electrical energy consumption data;
identifying one or more constituent electrical devices contributing to the significant energy events; and
deriving supplemental content comprising one or more annotations adapted to overlay the externally-produced historical electrical energy consumption data, wherein at least a portion of the annotations include indicia of the constituent electrical devices contributing to the significant energy events.

4. The method of claim 3, wherein at least a portion of the annotations include indicia of a monetary cost value allocated to the constituent electrical devices contributing to the significant energy events.

5. The method of claim 2, wherein the step of processing comprises:
deriving supplemental content comprising one or more customized displays of historical electric energy consumption data associated with the customer premises.

6. The method of claim 5, wherein the customized displays include a cycled display of plurality of varied presentations of energy consumption data.

7. The method of claim 5, wherein the customized displays include one or more presentations of energy consumption data corresponding to one or more user-selectable time periods.

8. The method of claim 1, wherein the utility meter comprises a smart meter associated with an electrical utility, and wherein the electrical utility implements a time-variable cost structure corresponding to various predetermined time periods.

9. The method of claim 8, wherein the content provider comprises an online energy monitoring service and wherein the externally-produced content includes one or more displays of electric energy consumption data associated with the customer premises.

10. The method of claim 9, further comprising:
receiving indicia of the time-variable cost structure; and
deriving supplemental content comprising one or more displays of the time-variable cost structure adapted to overlay the externally-produced historical electrical energy consumption data.

11. Apparatus for enhancing consumer awareness of utility consumption and cost data, in accordance with a communication system including a user platform operably connected to a utility meter, the apparatus at the user platform comprising:
a memory;
a display; and
at least one processor coupled to the memory and display and configured to:
receive indicia of utility consumption information corresponding to utility services used at a customer premises;
communicate the utility consumption information to a content provider that is adapted to deliver display content corresponding to the utility consumption information, the display content defining externally-produced content;
receive the externally-produced content;
process one or more of the externally-produced content or the utility consumption information to derive one or more instances of supplemental content, wherein the supplemental content is adapted to supplement the externally-produced content; and
display at least a portion of the supplemental content simultaneously with the externally-produced content.

12. Apparatus for enhancing consumer awareness of electrical utility consumption and cost data, in accordance with a communication system including a user platform operably connected to one of a legacy meter and a smart meter associated with an electrical utility, the apparatus at the user platform comprising:
a memory;
a display; and
at least one processor coupled to the memory and display and configured to:
receive indicia of utility consumption information corresponding to utility services used at a customer premises;
communicate the utility consumption information to an online energy monitoring service that is adapted to deliver one or more displays of historical electric energy consumption data associated with the customer premises, the displays from the online energy monitoring service defining externally-produced content;
receive the externally-produced content;
process one or more of the externally-produced content or the utility consumption information to derive one or more instances of supplemental content, wherein the supplemental content is adapted to supplement the externally-produced content; and
display at least a portion of the supplemental content simultaneously with the externally-produced content.

13. The apparatus of claim 12, wherein the processor is configured to:
detect one or more significant energy events associated with the historical electrical energy consumption data;
identify one or more constituent electrical devices contributing to the significant energy events; and
derive supplemental content comprising one or more annotations adapted to overlay the externally-produced historical electrical energy consumption data, wherein at least a portion of the annotations include indicia of the constituent electrical devices contributing to the significant energy events.

14. The apparatus of claim 12, wherein the processor is configured to:
derive supplemental content comprising one or more customized displays of historical electric energy consumption data associated with the customer premises.

15. The apparatus of claim 14, wherein the customized displays include a cycled display of plurality of varied presentations of energy consumption data.

16. The apparatus of claim 14, wherein the customized displays include one or more presentations of energy consumption data corresponding to one or more user-selectable time periods.

17. The apparatus of claim 12, wherein the processor is configured to:
receive indicia of a time-variable cost structure implemented by the electrical utility, the time-variable cost structure defining electrical energy costs corresponding to various predetermined time periods.

18. The apparatus of claim 17, wherein the processor is configured to:
derive supplemental content comprising one or more displays of the time-variable cost structure adapted to overlay the externally-produced historical electrical energy consumption data.
